(19) United States
(12) Patent Application Publication
(10) Pub. No.: US 2014/0278775 A1
(43) Pub. Date: Sep. 18, 2014

(54) METHOD AND SYSTEM FOR DATA CLEANSING TO IMPROVE PRODUCT DEMAND FORECASTING

(71) Applicant: Teradata Corporation, Dayton, OH (US)

(72) Inventors: Tsz Yu Chan, Boston, MA (US); Ghadamali Bagherikaram, Aurora, CA (US)

(73) Assignee: Teradata Corporation, Dayton, OH (US)

(21) Appl. No.: 14/208,295

(22) Filed: Mar. 13, 2014

Related U.S. Application Data
(60) Provisional application No. 61/783,400, filed on Mar. 14, 2013.

(51) Int. Cl. G06Q 30/02

(52) U.S. Cl. CPC G06Q 30/0202
USPC 705/7.31

(57) ABSTRACT

A method for cleansing product demand data to improve product demand forecasting. The improved data cleansing methodology enhances product weekly demand forecast accuracy by adjusting stock-out week demand values, and employing separate outlier logic for regular and promotional demand periods.

### CROSS REFERENCE TO RELATED APPLICATIONS

This application claims priority under 35 U.S.C. §119(e) to the following co-pending and commonly-assigned patent application, which is incorporated herein by reference:

Provisional Patent Application Ser. No. 61/783,400, entitled “METHOD AND SYSTEM FOR DATA CLEANSING TO IMPROVE PRODUCT DEMAND FORECASTING,” filed on Mar. 14, 2013, by David Chan and Ghadamali Bagherikaram.

This application is related to the following commonly-assigned patents and patent applications, which are incorporated by reference herein:

Application Ser. No. 11/613,404, entitled “IMPROVED METHODS AND SYSTEMS FOR FORECASTING PRODUCT DEMAND USING A CAUSAL METHODOLOGY,” filed on Dec. 20, 2006, by Arash Bateni, Edward Kim, Philip Liew, and J. P. Vorsanger;

Application Ser. No. 11/967,645, entitled “TECHNIQUES FOR CAUSAL DEMAND FORECASTING,” filed on Dec. 31, 2007, by Arash Bateni, Edward Kim, J. P. Vorsanger, and Rong Zong;

Application Ser. No. 12/982,251, entitled “METHODS AND SYSTEMS FOR FORECASTING PRODUCT DEMAND USING PRICE ELASTICITY OF DEMAND WITHIN A CAUSAL METHODOLOGY,” filed on Dec. 30, 2010, by Arash Bateni and Edward Kim;

Application Ser. No. 13/691,679, entitled METHODS AND SYSTEMS FOR FORECASTING PRODUCT DEMAND FOR PRODUCTS WITH DYNAMIC SALES PATTERNS,” filed on Nov. 30, 2012, by Arash Bateni and David Chan; and

U.S. Pat. No. 7,996,254, entitled “IMPROVED METHODS AND SYSTEMS FOR FORECASTING PRODUCT DEMAND DURING PROMOTIONAL EVENTS USING A CAUSAL METHODOLOGY,” issued on Aug. 9, 2011, by Arash Bateni, Edward Kim, Harmintar Atwal, and J. P. Vorsanger.

### FIELD OF THE INVENTION

The present invention relates to methods and systems for forecasting product demand using a causal methodology, based on multiple regression techniques, and in particular to an improved method for forecasting product demand including a data cleansing process.

### BACKGROUND OF THE INVENTION

Accurate demand forecasts are crucial to a retailer's business activities, particularly inventory control and replenishment, and hence significantly contribute to the productivity and profit of retail organizations. Additionally, predicting the impact of promotions and price discounts on product demand is crucial for retail marketing, promotion planning, and replenishment activities.

Aprimo, a division of Teradata Corporation, has developed a suite of analytical applications for the retail business, referred to as Aprimo Demand Chain Management (DCM), which provides retailers with the tools they need for product demand forecasting, planning and replenishment. The Aprimo Demand Chain Management forecasting application assists retailers in accurately forecasting product sales at the store/SKU (Stock Keeping Unit) level to ensure high customer service levels are met, and inventory stock at the store level is optimized and automatically replenished. The Aprimo DCM forecasting application helps retailers anticipate increased demand for products and plan for customer promotions by providing the tools to do effective product forecasting through a responsive supply chain.

In U.S. patent application Ser. Nos. 11/613,404; 11/967,645; 12/982,251; and 12/982,251; and U.S. Pat. No. 7,996,254; Teradata Corporation has presented improvements to the DCM Application Suite for forecasting and modeling product demand during promotional and non-promotional periods. The forecasting methodologies described in these references seek to establish a cause-effect relationship between product demand and factors influencing product demand in a market environment. Such factors may include current product sales rates, product price changes, promotional activities, competitive information, weather conditions, and other factors. A product demand forecast is generated by combining an uplift coefficient determined through regression analysis of weekly historical demand data and the causal factors influencing product demand, with an Average Rate of Sale (ARS) value generated by the DCM application, and a seasonal factor selected for the product.

This novel methodology, referred to as Regression Event Uplift (REU), analyzes the impact of historical promotions on future promotional sales. It uses a methodology that calculates and models the partial role of various causal factors on the demand simultaneously. It is a multiple regression model that analyzes the effect of several causal factors such as price discount, media type, duration of promotion, etc. REU calculates a set of coefficients for each input variable which are used to forecast the future promotional uplifts.

Incorrect or inconsistent data, referred to as noise, in a customers' data can create problems in REU calculations. Incorrect or inconsistent data can lead to false conclusions and misdirected results for regression analysis. It is therefore important to employ a strong cleansing logic in the REU module to prevent anomalies and unexpected data points being fed into the regression analysis.

A new implementation of REU, employing an improved data cleansing methodology, is described below.

### BRIEF DESCRIPTION OF THE DRAWINGS

FIG. 1 provides a high level architecture diagram of a web-based three-tier client-server computer system architecture.

FIG. 2 provides an illustration of the Aprimo DCM forecasting, planning and replenishment software application suite shown in FIG. 1.

FIG. 3 is a flow chart illustrating a method for determining product demand forecasts utilizing a multivariable regression model to model the causal relationship between product demand and the attributes of past sales activities.

FIG. 4 provides a flow diagram of the Regression Event Uplift process for products categorized according to historical promotional behavior.

FIG. 5 provides a more detailed flow diagram of the Regression Event Uplift process for products categorized according to historical promotional behavior.

FIG. 6 is a graph illustrating the identification of outlier values.

FIG. 7 is a graph illustrating differences in outlier tolerance values for promotional and regular demand.

FIG. 8 is a flow chart illustrating a method for determining regression coefficients and product demand forecasts for products in accordance with the present invention.

### DETAILED DESCRIPTION OF THE INVENTION

In the following description, reference is made to the accompanying drawings that form a part hereof, and in which is shown by way of illustration specific embodiments in which the invention may be practiced. These embodiments are described in sufficient detail to enable one of ordinary skill in the art to practice the invention, and it is to be understood that other embodiments may be utilized and that structural, logical, optical, and electrical changes may be made without departing from the scope of the present invention. The following description is, therefore, not to be taken in a limited sense, and the scope of the present invention is defined by the appended claims.

As stated above, the causal demand forecasting methodology seeks to establish a cause-effect relationship between product demand and factors influencing product demand in a market environment. A product demand forecast is generated by blending the various influencing factors in accordance with corresponding regression coefficients determined through the analysis of historical product demand and factor information. The multivariable regression equation can be expressed as:

LN=base+α₁var₁+α₂var₂+ . . . +αₙvarₙ;

where LN represents demand; var₁ through varₙ represent causal variables, such as current product sales rate, product price, weather, promotional activities, and other factors; and α₁ through αₙ represent regression coefficients determined through regression analysis using historical sales, price, promotion, and other causal data.

The Aprimo DCM Application Suite may be implemented within a three-tier computer system architecture as illustrated in FIG. 1. The three-tier computer system architecture is a client-server architecture in which the user interface, application logic, and data storage and data access are developed and maintained as independent modules, most often on separate platforms. The three tiers are identified in FIG. 1 as presentation tier 101, application tier 102, and database access tier 103.

Presentation tier 101 includes a PC or workstation 111 and standard graphical user interface enabling user interaction with the DCM application and displaying DCM output results to the user. Application tier 103 includes an application server 113 hosting the DCM software application 114. Database tier 103 includes a database server containing a database 116 of product price and demand data accessed by DCM application 114.

As illustrated in FIG. 2 the Aprimo Demand Chain Management analytical application suite 114 is shown to be part of a data warehouse solution for the retail industries built upon Teradata Corporation's Teradata Data Warehouse 201, using a Teradata Retail Logical Data Model (RLDM). The key modules contained within the Aprimo Demand Chain Management application suite 114, are:

Contribution: Contribution module 211 provides an automatic categorization of SKUs, merchandise categories and locations based on their contribution to the success of the business. These rankings are used by the replenishment system to ensure the service levels, replenishment rules and space allocation are constantly favoring those items preferred by the customer.

Seasonal Profile: The Seasonal Profile module, also referred to as the Intelligent Profile (IPC) Clustering module, 212 automatically calculates seasonal selling patterns at all levels of merchandise and location. This module draws on historical sales data to automatically create seasonal models for groups of items with similar seasonal patterns. The model might contain the effects of promotions, markdowns, and items with different seasonal tendencies.

Demand Forecasting: The Demand Forecasting module 213 provides store/SKU level forecasting that responds to unique local customer demand. This module considers both an item's seasonality and its rate of sales (sales trend) to generate an accurate forecast. The module continually compares historical and current demand data and utilizes several methods to determine the best product demand forecast.

Promotions Management: The Promotions Management module 214 automatically calculates the precise additional stock needed to meet demand resulting from promotional activity.

Automated Replenishment: Automated Replenishment module 215 provides the retailer with the ability to manage replenishment both at the distribution center and the store levels. The module provides suggested order quantities based on business policies, service levels, forecast error, risk stock, review times, and lead times.

Time Phased Replenishment: Time Phased Replenishment module 216 Provides a weekly long-range order forecast that can be shared with vendors to facilitate collaborative planning and order execution. Logistical and ordering constraints such as lead times, review times, service-level targets, min/max shelf levels, etc. can be simulated to improve the synchronization of ordering with individual store requirements.

Allocation: The Allocation module 217 uses intelligent forecasting methods to manage pre-allocation, purchase order and distribution center on-hand allocation.

Load Builder: Load Builder module 218 optimizes the inventory deliveries coming from the distribution centers (DCs) and going to the retailer's stores. It enables the retailer to review and optimize planned loads.

Capacity Planning: Capacity Planning module 219 looks at the available throughput of a retailer's supply chain to identify when available capacity will be exceeded.

FIG. 3 is a flow chart illustrating a casual method for forecasting promotional product demand, as described in greater detail in U.S. patent application Ser. No. 11/938,812, referred to above. The demand forecasting technique described therein employs a multivariable regression model to model the causal relationship between product demand and the attributes of past promotional activities. The model is utilized to calculate the promotional uplift from the coefficients of the regression equation. The methodology consists of two main steps a) regression: calculation of regression coefficients, and b) coefficient transformation: calculation of the promo uplift.

Referring to FIG. 3, historical weekly sales (demand) data 304, seasonal adjustment factors (SFs) 306, and tracked causal factors 308, are saved for each product or service offered by the retailer.

In step 320, the historical demand data for products having seasonal selling patterns is adjusted, i.e., deseasonalized, by dividing the actual historical demand values by their corresponding seasonal factors according to equation 1, dsdemand_{yr,wk}=demand_{yr,wk}/SF_{wk}. The seasonally adjusted demand (dsdemand) is then used as input to the causal framework and the forecasting module of the DCM forecasting application.

In step 330, regression preprocessing is performed to select the set of causal factors that have statistically significant effects on historical product demand, and to prepare the causal factor data 208 for analysis.

In step 340, regression coefficients (α₁, α₂, α₃, . . . αₙ) are calculated using the deseasonalized demand data and tracked causal factors 308. These regression coefficients are combined in step 350 to generate an uplift coefficient for each product.

In step 360, the uplift coefficient is combined with the DCM Average Rate of Sale (ARS) calculation results provided by the forecasting module of the DCM forecasting application for the product, and the appropriate seasonal factor, to generate the final product demand forecast for the product:

FCSTᵢ=ARSᵢ×SFᵢ×upliftᵢ

### REU Process

FIG. 4 provides a high-level flow diagram of an updated Regression Event Uplift process including separate data analysis processes for different product data model types. A more detailed flow diagram of the Regression Event Uplift process is provided in FIG. 5. FIG. 8 provides a high-level flow chart of the REU algorithm. Referring to FIGS. 4 and 5, processes are organized into three modules: Data Transformation 410, Model Assignment 420, and Model Analysis 430.

Within the Data Transformation module 410, processes are provided for data extraction 412, e.g., extraction of sales data, discounts, media types, promotions, and other information; de-seasonalization 414, i.e., the removal of seasonal affects from historical demand data; and initial demand analysis 416, e.g., stockout replacement analysis, regular demand outlier analysis, partially promoted week analysis, etc.

Model Assignment module 420 includes processes 422 and 424 for assigning model types to each product within a department and location (PDL). Products are categorized according to historical promotional behavior into four different model types:
HH—SKUs (Stock Keeping Units) with High regular demand and historically a High number of promotions.
LH—SKUs with Low regular demand but a history of a High number of promotions.
GRP—User-defined group, e.g., SKUs with similar behavior, such as similar rates of sale or similar pricing.
AGG—SKUs grouped based on media type, class hierarchy, and location hierarchy.

Model Analysis module 430 includes separate analysis processes for the different model types. HH model processes 440 include dynamic sale pattern analysis 442, outlier analysis 444, media analysis 446, and regression analysis 448. Similarly, LH models processes 450 include outlier analysis 452, media analysis 454, and regression analysis 456; and AGG/GRP model processes 460 include media analysis 462, dynamic sale pattern analysis 464, outlier analysis 466, and regression analysis 468.

### Data Cleansing and Outlier Logic

As stated earlier, incorrect or inconsistent data, referred to as noise, in a customers' data can create problems in REU calculations. Incorrect or inconsistent data can lead to false conclusions and misdirected results for regression analysis. Incorrect or inconsistent data is often revealed as outliers—data points which are distant from the majority of data points in a dataset—and should be removed from REU calculations.

FIG. 6 provides a graph illustrating the identification of outlier values. Referring to FIG. 6, historical weekly sales data for an exemplary product is illustrated by graph-line 610. Weekly sales are seen to range from a low value of 0 unit sales in week 2, to high sales values of 4 units in week 3, and 5 units in week 7. The mean weekly sales, represented by dashed line 620, is 1.9 units. Outlier boundary values, shown by dotted lines 630 and 640, define the normal range for weekly product sales. Values outside the boundaries established by lines 630 and 640, e.g., data points 612, 614 and 616, are identified as outliers.

The identification of outliers in product sales data for products that are frequently promoted can be more difficult, as sales values during product promotions may significantly exceed average sales during non-promotional periods. FIG. 7 provides a graph illustrating the potential differences in promotional and regular product demand. Referring to FIG. 7, weekly product sales for a frequently promoted product is illustrated by graph-line 710. Average weekly product sales values for regular (non-promotional) sales is shown by dotted line 720, average weekly promotional product sales is shown by line 730, and average weekly total (regular and promotional) product sales is shown by line 740. As shown, the average weekly promotional product sale value greatly exceeds both regular and total average weekly product sale values.

Establishing a single set of high and low boundary values to identify regular (non-promotional) sales outliers may erroneously identify promotional sales values as outliers, whereas establishing a single set of high and low boundary values to identify outliers based upon promotional, or the total of promotional and non-promotional sales, may fail to identify regular sales outliers.

A new implementation of the REU algorithm employing an improved data cleansing methodology is illustrated by the flow chart of FIG. 8. Referring to FIG. 8, data transformation functions are performed in steps 801 through 809; model assignment to HH, LH, GRP, and AGG model types is shown by step 810; and model analysis functions performed in steps 811 through 817. These functions were also discussed above with references to FIGS. 4 and 5.

The updated REU algorithm includes the following data cleansing steps which enhance the forecast accuracy:
Adjustment of stock-out week demands (step 803);
Separated outlier logic on regular (step 807) and promotional (step 802) demands; and
Addition of a system switch to control the number of times that outlier logic applies on promotional demands

A more detailed explanation of these data cleansing steps is provided below:

### 1. Adjustment of Stock-Out Week Demands (FIG. 8, Step 803).

To adjust the demands on a stock-out week (wk):
   Calculate the expected demand ExpDmnd(wk) using past 13 regular weeks moving average, and:
      I. Exclude any previous week with promotion,
      II. Exclude any previous week with stock-out, and
      III. Calculate

$$ExpDmnd ( wk ) = \frac{{\sum }_{i = 1}^{13} RegularDemand ( wk - i )}{\# of weeks} .$$

If ExpDmnd(wk)>regular demand RegularDemand(wk), replace RegularDemand(wk) with ExpDmnd (wk).

### 2. Separated Outlier Logic.

There is always some random noise inside the demand data. It is important to replace noisy data with smoothed data. This step can be done by applying a solid outlier logic on the total demands. Total sales value, however, have high variations compared to the average sale. Performing outlier logic on total demands is therefore less efficient. The following separated outlier logic for regular and promotional demands is proposed.
   Outlier logic for regular demands (FIG. 8, step 807):
      I. Calculate the 13 weeks moving average (E) of regular sales,
      II. Calculate standard deviation (δ) of 13 weeks regular sales, and
      III. For each regular week (wk) replace the regular demand as follows:

$$RegularDemand ( wk ) = \{ \begin{matrix}E + 3 δ , & RegularDemand ( wk ) > E + 3 δ \\ RegularDemand ( wk ) , & Otherwise .\end{matrix}$$

Outlier logic for promotional demands—LH Model (FIG. 5, step 452; FIG. 8, step 812). The following logic is repeated twice (controlled by system parameter) for each SKU/Location:
   I. Exclude the following data points:
      a. Promo demand is less than or equal to zero, and
      b. Promo demand is less than or equal to estimated regular demand,
   II. Calculate Slope (m) and Intercept (I) for all promotion weeks using linear regression. (x=price %; y=prom sales),
   III. Calculate expected promo Sales for each prom week: Expected Prom Sales[wk]=Intercept+Slope*Price %[wk],
   IV. Calculate absolute value of residual for each prom week: Residual[wk]=|Actual Prom Sales[wk]−Expected Prom Sales[wk]|,
   V. Calculate mean ( R̅E̅S̅) and standard deviation (δ_{RES}) for the Residuals, and
   VI. Eliminate the prom weeks data when Residual[wk]> R̅E̅S̅+1.5δ_{RES}.
Outlier logic for historical uplifts-HH, AGG, and GRP Models (FIG. 5, steps 444 and 466, FIG. 8, step 812). The following logic is repeated twice (controlled by system parameter) for each SKU/Location:
   I. Calculate the average historical uplift (ū),
   II. Calculate the standard deviation (δ) based on historical uplift,
   III. If historical uplift is greater than (ū+3δ), replace historical uplift with (ū+3δ), and
   IV. If historical uplift is less than (ū−3δ), replace historical uplift with (ū−3δ).

Instructions of the various software routines discussed herein, are stored on one or more storage modules in the system shown in FIGS. 1 and 2 and loaded for execution on corresponding control units or processors. The control units or processors include microprocessors, microcontrollers, processor modules or subsystems, or other control or computing devices. As used here, a “controller” refers to hardware, software, or a combination thereof. A “controller” can refer to a single component or to plural components, whether software or hardware.

Data and instructions of the various software routines are stored in respective storage modules, which are implemented as one or more machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs).

The instructions of the software routines are loaded or transported to each device or system in one of many different ways. For example, code segments including instructions stored on floppy disks, CD or DVD media, a hard disk, or transported through a network interface card, modem, or other interface device are loaded into the device or system and executed as corresponding software modules or layers.

The foregoing description of various embodiments of the invention has been presented for purposes of illustration and description. It is not intended to be exhaustive or to limit the invention to the precise form disclosed. Many alternatives, modifications, and variations will be apparent to those skilled in the art in light of the above teaching.

What is claimed is:

1. A computer-implemented method for identifying outliers within a data sample, the method comprising the steps of:
maintaining, in a data storage device, a database of historical demand information for a product, said historical demand information comprising regular demand values corresponding to non-promotional historical product sales, and promotional demand values corresponding to promotional historical product sales;
establishing high and low boundary values for said regular demand values, and high and low boundary values for said promotional demand values;
identifying, by a computer in communication with said data storage device, an individual regular demand value as an outlier regular demand value when said individual regular demand value is above, or below, said high and low boundary values for said regular demand values, respectively; and
identifying, by said computer, an individual promotional demand value as an outlier promotional demand value when said individual promotional demand value is above, or below, said high and low boundary values for said promotional demand values, respectively.

2. The computer-implemented method for identifying outliers within a data sample in accordance with claim 1, further comprising the step of:
when said individual regular demand value is above said high boundary value for said regular demand values, setting, by said computer, said individual regular demand value to be equivalent to said high boundary value for said regular demand values; and
when said individual regular demand value is below low boundary value for said regular demand values, setting, by said computer, said individual regular demand value identified to be equivalent to said low boundary value for said regular demand values.

3. The computer-implemented method for identifying outliers within a data sample in accordance with claim 1, further comprising the steps of:
analyzing, by said computer, said regular demand values to determine an average regular demand value (E);
determining, by said computer, a standard deviation (δ) for said regular demand values;
setting said high boundary value for said regular demand values to said average regular demand value plus three times said standard deviation for said regular demand values (E+3δ); and
setting said low boundary value for said regular demand values to said average regular demand value less three times said standard deviation for said regular demand values (E−3δ).

4. The computer-implemented method for identifying outliers within a data sample in accordance with claim 1, further comprising the steps of:
when said individual promotional demand value is above said high boundary value for said promotional demand values, setting, by said computer, said individual promotional demand value identified as an outlier to be equivalent to said high boundary value for said promotional demand values; and
when said individual promotional demand value is below low boundary value for said promotional demand values, setting, by said computer, said individual promotional demand value identified as an outlier to be equivalent to said low boundary value for said promotional demand values.

5. The computer-implemented method for identifying outliers within a data sample in accordance with claim 1, further comprising the steps of:
determining, by said computer, historical uplifts for said promotional demand values;
analyzing, by said computer, said historical uplifts to determine an average historical uplift (ū);
determining, by said computer, a standard deviation (δ) for said historical uplifts;
setting a high boundary value for said historical uplifts to said average historical uplift plus said standard deviation for said historical uplifts (ū+3δ);
setting a low boundary value for said historical uplifts to said average historical uplift minus said standard deviation for said historical uplifts (ū+3δ); and
identifying, by said computer, an individual historical uplift as an outlier historical uplift when said individual historical uplift is above, or below, said high and low boundary values for said historical uplifts.

6. The computer-implemented method for identifying outliers within a data sample in accordance with claim 5, further comprising the steps of:
when said individual historical uplift is above said high boundary value for said historical uplifts, setting, by said computer, said individual historical uplift to be equivalent to said high boundary value for said historical uplifts; and
when said individual historical uplift is below low boundary value for said historical uplifts, setting, by said computer, said individual historical uplift to be equivalent to said low boundary value for said historical uplifts.

7. The computer-implemented method for identifying outliers within a data sample in accordance with claim 1, wherein:
said regular demand values are weekly demand values for non-promotional historical product sales; and
said promotional demand values are weekly demand values for promotional historical product sales.

8. A computer system comprising:
a data storage device containing a database of historical demand information for a product, said historical demand information comprising regular demand values corresponding to non-promotional historical product sales, and promotional demand values corresponding to promotional historical product sales;
a computer in communication with said data storage device for:
identifying an individual regular demand value as an outlier regular demand value when said individual regular demand value is above, or below, high and low boundary values established for said regular demand values, and high and low boundary values for said promotional demand values, respectively; and
identifying an individual promotional demand value as an outlier promotional demand value when said individual promotional demand value is above, or below, high and low boundary values for said promotional demand values established for said promotional demand values, respectively.

9. The computer system in accordance with claim 8, wherein said computer:
when said individual regular demand value is above said high boundary value for said regular demand values, sets said individual regular demand value to be equivalent to said high boundary value for said regular demand values; and
when said individual regular demand value is below low boundary value for said regular demand values, sets said individual regular demand value identified to be equivalent to said low boundary value for said regular demand values.

10. The computer system in accordance with claim 8, wherein said computer:
analyzes said regular demand values to determine an average regular demand value (E);
determines a standard deviation (δ) for said regular demand values;
sets said high boundary value for said regular demand values to said average regular demand value plus three times said standard deviation for said regular demand values (E+3δ); and
sets said low boundary value for said regular demand values to said average regular demand value less three times said standard deviation for said regular demand values (E−3δ).

11. The computer system in accordance with claim 8, wherein said computer:
when said individual promotional demand value is above said high boundary value for said promotional demand values, sets said individual promotional demand value identified as an outlier to be equivalent to said high boundary value for said promotional demand values; and
when said individual promotional demand value is below low boundary value for said promotional demand values, sets said individual promotional demand value identified as an outlier to be equivalent to said low boundary value for said promotional demand values.

12. The computer system in accordance with claim 8, wherein said computer:
determines historical uplifts for said promotional demand values;
analyzes said historical uplifts to determine an average historical uplift (ū);
determines a standard deviation (δ) for said historical uplifts;
sets a high boundary value for said historical uplifts to said average historical uplift plus said standard deviation for said historical uplifts (ū+3δ);
sets a low boundary value for said historical uplifts to said average historical uplift minus said standard deviation for said historical uplifts (ū+3δ); and
identifying, by said computer, an individual historical uplift as an outlier historical uplift when said individual historical uplift is above, or below, said high and low boundary values for said historical uplifts.

13. The computer system in accordance with claim 12, wherein said computer:
when said individual historical uplift is above said high boundary value for said historical uplifts, sets said individual historical uplift to be equivalent to said high boundary value for said historical uplifts; and
when said individual historical uplift is below low boundary value for said historical uplifts, sets said individual historical uplift to be equivalent to said low boundary value for said historical uplifts.

14. The computer system in accordance with claim 12, wherein:
said regular demand values are weekly demand values for non-promotional historical product sales; and
said promotional demand values are weekly demand values for promotional historical product sales.

15. A non-transitory computer-readable medium having a computer program for identifying outliers within a database of historical demand information for a product, said historical demand information comprising regular demand values corresponding to non-promotional historical product sales, and promotional demand values corresponding to promotional historical product sales data sample, the computer program including executable instructions that cause a computer to:
identify an individual regular demand value as an outlier regular demand value when said individual regular demand value is above, or below, high and low boundary values established for said regular demand values, and high and low boundary values for said promotional demand values, respectively; and
identify an individual promotional demand value as an outlier promotional demand value when said individual promotional demand value is above, or below, high and low boundary values for said promotional demand values established for said promotional demand values, respectively.

16. The non-transitory computer-readable medium having a computer program for identifying outliers within a database of historical demand information for a product in accordance with claim 15, the computer program including executable instructions causes said computer to:
when said individual regular demand value is above said high boundary value for said regular demand values, set said individual regular demand value to be equivalent to said high boundary value for said regular demand values; and
when said individual regular demand value is below low boundary value for said regular demand values, set said individual regular demand value identified to be equivalent to said low boundary value for said regular demand values.

17. The non-transitory computer-readable medium having a computer program for identifying outliers within a database of historical demand information for a product in accordance with claim 15, the computer program including executable instructions causes said computer to:
analyze said regular demand values to determine an average regular demand value (E);
determine a standard deviation (δ) for said regular demand values;
set said high boundary value for said regular demand values to said average regular demand value plus three times said standard deviation for said regular demand values (E+3δ); and
set said low boundary value for said regular demand values to said average regular demand value less three times said standard deviation for said regular demand values (E−3δ).

18. The non-transitory computer-readable medium having a computer program for identifying outliers within a database of historical demand information for a product in accordance with claim 15, the computer program including executable instructions causes said computer to:
when said individual promotional demand value is above said high boundary value for said promotional demand values, set said individual promotional demand value identified as an outlier to be equivalent to said high boundary value for said promotional demand values; and
when said individual promotional demand value is below low boundary value for said promotional demand values, set said individual promotional demand value identified as an outlier to be equivalent to said low boundary value for said promotional demand values.

19. The non-transitory computer-readable medium having a computer program for identifying outliers within a database of historical demand information for a product in accordance with claim 15, the computer program including executable instructions causes said computer to:
determine historical uplifts for said promotional demand values;
analyze said historical uplifts to determine an average historical uplift (ū);
determine a standard deviation (δ) for said historical uplifts;
set a high boundary value for said historical uplifts to said average historical uplift plus said standard deviation for said historical uplifts (ū+3δ);
set a low boundary value for said historical uplifts to said average historical uplift minus said standard deviation for said historical uplifts (ū+3δ); and
identify an individual historical uplift as an outlier historical uplift when said individual historical uplift is above, or below, said high and low boundary values for said historical uplifts.

20. The non-transitory computer-readable medium having a computer program for identifying outliers within a database of historical demand information for a product in accordance with claim 19, the computer program including executable instructions causes said computer to:
when said individual historical uplift is above said high boundary value for said historical uplifts, set said individual historical uplift to be equivalent to said high boundary value for said historical uplifts; and
when said individual historical uplift is below low boundary value for said historical uplifts, set said individual historical uplift to be equivalent to said low boundary value for said historical uplifts.
